(19) United States
(12) Patent Application Publication
(10) Pub. No.: US 2026/0098132 A1
(43) Pub. Date: Apr. 9, 2026

(54) POLYARYLENE SULFIDE RESIN COMPOSITION

(71) Applicant: Polyplastics Co., Ltd., Tokyo (JP)

(72) Inventor: Ryosuke Tachibori, Fuji-shi (JP)

(73) Assignee: Polyplastics Co., Ltd., Tokyo (JP)

(21) Appl. No.: 19/106,768

(22) PCT Filed: Aug. 29, 2023
(86) PCT No.: PCT/JP2023/031136

§ 371 Date: Feb. 26, 2025

(30) Foreign Application Priority Data
Sep. 1, 2022 (JP) 2022-139353

(51) Int. Cl. C08J 5/10; C08J 5/04; C08K 5/544; C08K 7/14

(52) U.S. Cl. CPC C08J 5/10; C08J 5/043; C08K 5/544; C08K 7/14; C08J 2381/02

(57) ABSTRACT

The polyarylene sulfide resin composition contains a (A) polyarylene sulfide resin; a (B) fibrous inorganic filler that has a different diameter ratio, which is the ratio of the long diameter and the short diameter of a cross section perpendicular to the longitudinal direction, of 3.0 or more; and an (C) alkoxysilane compound. The cooling crystallization temperature (Tc) of the (A) polyarylene sulfide resin is 215° C. or more; the content of the (B) fibrous inorganic filler that has an different diameter ratio, which is the ratio of the long diameter and short diameter of a cross section perpendicular to the longitudinal direction, of 3.0 or more, is 55 to 180 parts by mass per 100 parts by mass of the (A) polyarylene sulfide resin; and the content of the (C) alkoxysilane compound is 0.5 to 10 parts by mass per 100 parts by mass of the (A) polyarylene sulfide resin.

### TECHNICAL FIELD

The present invention relates to a polyarylene sulfide resin composition.

### BACKGROUND

Polyarylene sulfide resins, typified by polyphenylene sulfide resins, are widely used for electrical and electronic device part materials, automobile part materials, chemical device part materials, and the like, because of their excellent thermal resistance, mechanical properties, chemical resistance, dimensional stability, and flame retardancy.

In order to increase the mechanical strength of polyarylene sulfide resin molded articles, techniques such as blending glass fibers having a flat cross-sectional shape (e.g., Patent Document 1) and blending a filler whose surface has been treated with an alkoxysilane compound (e.g., Patent Document 2) have been considered.
Patent Document 1: WO 2021/157162 A
Patent Document 2: JP H08-012886 A

### SUMMARY OF INVENTION

An object of the present invention is to provide a polyarylene sulfide resin composition that provides a molded article having excellent flexural strength and impact strength.

The present invention has the following aspects.

[1] A polyarylene sulfide resin composition containing a (A) polyarylene sulfide resin, a (B) fibrous inorganic filler having a different diameter ratio, which is the ratio of the long diameter and short diameter of a cross section perpendicular to the longitudinal direction, of 3.0 or more, and an (C) alkoxysilane compound,
wherein the cooling crystallization temperature (Tc) of the (A) polyarylene sulfide resin is 215° C. or more, and the cooling crystallization temperature (Tc) is an exothermic peak temperature associated with crystallization observed when the (A) polyarylene sulfide resin is heated to 340° C., melted, and then cooled at a rate of 10° C./min with a differential scanning calorimeter;
the content of the (B) fibrous inorganic filler having a different diameter ratio, which is the ratio of the long diameter and short diameter of a cross section perpendicular to the longitudinal direction, of 3.0 or more is 55 to 180 parts by mass per 100 parts by mass of the (A) polyarylene sulfide resin; and
the content of the (C) alkoxysilane compound is 0.5 to 10 parts by mass per 100 parts by mass of the (A) polyarylene sulfide resin.

[2] The polyarylene sulfide resin composition according to [1], wherein the alkoxysilane compound (C) contains one or more alkoxysilane compounds having one or more selected from an epoxy group, an amino group, a vinyl group, a (meth)acrylic group, an isocyanate group, and a mercapto group.

[3] The polyarylene sulfide resin composition according to [1] or [2], wherein the (B) fibrous inorganic filler having a different diameter ratio, which is the ratio of the long diameter and short diameter of a cross section perpendicular to the longitudinal direction, of 3.0 or more contains glass fibers.

According to the present invention, it is possible to provide a polyarylene sulfide resin composition that can provide a molded article having excellent flexural strength and impact strength.

### DESCRIPTION OF EMBODIMENTS

An embodiment of the present invention will be described in detail below, but the scope of the present invention is not limited to the embodiment described here, and various modifications can be made without departing from the spirit of the present invention. In addition, when multiple upper and lower limit values are described for a specific parameter, any upper and lower limit values can be combined to form a suitable numerical range from among the upper limit values and the lower limit values. The expression “X to Y” indicating a numerical range means “X or more and Y or less.” When a specific description described for one embodiment is also applicable to other embodiments, the description may be omitted in the other embodiments.

### [Polyarylene Sulfide Resin Composition]

The polyarylene sulfide resin composition (hereinafter, also simply referred to as the “resin composition”) according to the present embodiment includes a (A) polyarylene sulfide resin, a (B) fibrous inorganic filler having a different diameter ratio, which is the ratio of the long diameter and short diameter of a cross section perpendicular to the longitudinal direction, of 3.0 or more, and an (C) alkoxysilane compound, wherein the cooling crystallization temperature (Tc) of the (A) polyarylene sulfide resin is 215° C. or more, and the cooling crystallization temperature (Tc) is an exothermic peak temperature associated with crystallization observed when the (A) polyarylene sulfide resin is heated to 340° C., melted, and then cooled at a rate of 10° C./min with a differential scanning calorimeter; the content of the (B) fibrous inorganic filler having a different diameter ratio, which is the ratio of the long diameter and short diameter of a cross section perpendicular to the longitudinal direction, of 3.0 or more is 55 to 180 parts by mass per 100 parts by mass of the (A) polyarylene sulfide resin; and the content of the (C) alkoxysilane compound is 0.5 to 10 parts by mass per 100 parts by mass of the (A) polyarylene sulfide resin. According to the resin composition according to the present embodiment, a molded article having excellent flexural strength and impact strength can be provided.

### < (A) Polyarylene Sulfide Resin>

The (A) polyarylene sulfide resin is a resin having repeating units represented by the following general formula (I):

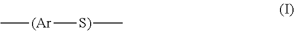

(wherein Ar represents an arylene group).

The arylene group is not particularly limited, and examples thereof include a p-phenylene group, an m-phenylene group, an o-phenylene group, a substituted phenylene group, a p,p′-diphenylene sulfone group, a p,p′-biphenylene group, a p,p′-diphenylene ether group, a p,p′-diphenylene carbonyl group, a naphthalene group, and the like. The (A) polyarylene sulfide resin can be a homopolymer using the same repeating unit among the repeating units represented by the above general formula (I), or a copolymer containing different types of repeating units depending on the application.

As the homopolymer, one having a p-phenylene group as an arylene group and a p-phenylene sulfide group as a repeating unit is preferable. This is because a homopolymer having a p-phenylene sulfide group as a repeating unit has extremely high thermal resistance, and exhibits high strength, high rigidity, and furthermore, high dimensional stability over a wide temperature range. By using such a homopolymer, a molded article with very excellent physical properties can be obtained.

As the copolymer, a combination of two or more different arylene sulfide groups among the above-mentioned arylene sulfide groups containing an arylene group can be used. Among these, a combination containing a p-phenylene sulfide group and an m-phenylene sulfide group is preferred from the viewpoint of obtaining a molded article with high physical properties such as thermal resistance, moldability, and mechanical properties. A polymer containing 70 mol % or more of a p-phenylene sulfide group is more preferred, and a polymer containing 80 mol % or more is even more preferred. The (A) polyarylene sulfide resin having a phenylene sulfide group is a polyphenylene sulfide resin (PPS resin).

Generally, polyarylene sulfide resins having a molecular structure that is substantially linear and has no branched or crosslinked structure, and a structure that has a branched or crosslinked structure are known, depending on the production method thereof, and either type may be used as the (A) polyarylene sulfide resin.

The melt viscosity of the (A) polyarylene sulfide resin measured at 310° C. and a shear rate of 1200 sec⁻¹ is preferably 3 to 250 Pa·s, more preferably 5 to 150 Pa·s, and even more preferably 8 to 80 Pa·s, from the viewpoint of improving moldability and toughness.

The cooling crystallization temperature (Tc) of the (A) polyarylene sulfide resin is 215° C. or more, preferably exceeds 215° C., more preferably is 216° C. or more, even more preferably is 220° C. or more, and particularly preferably is 230° C. or more. Surprisingly, when the cooling crystallization temperature (Tc) of the (A) polyarylene sulfide resin is 215° C. or more, a synergistic effect can be sufficiently obtained by using the (C) alkoxysilane compound described below in combination, and the flexural strength and impact strength of the molded article can be increased.

The upper limit value of the cooling crystallization temperature (Tc) of the (A) polyarylene sulfide resin is preferably 260° C. or less, more preferably is 250° C. or less, and particularly preferably is 240° C. or less.

In one embodiment, the cooling crystallization temperature (Tc) of the (A) polyarylene sulfide resin may be 215 to 260° C., may be more than 215° C. and 260° C. or less, may be 216 to 250° C., or may be 216 to 240° C. In one embodiment, the cooling crystallization temperature (Tc) of the (A) polyarylene sulfide resin may be 219° C., or may be within the range having this as the upper or lower limit value of the above numerical ranges.

The cooling crystallization temperature (Tc) is the exothermic peak temperature associated with crystallization observed when the (A) polyarylene sulfide resin is heated to 340° C., melted, and then cooled at a rate of 10° C./min with a differential scanning calorimeter.

As a method for adjusting the cooling crystallization temperature (Tc) of the (A) polyarylene sulfide resin to 215° C. or more, a method using a washing treatment after polymerization is preferable because it is simple in terms of process, but is not necessarily limited to this method. An example of a method using a washing treatment, for example, is a method in which the polymer after polymerization is washed with an acidic aqueous solution of appropriate acidity. In this case, the acid used as the acidic aqueous solution may be inorganic acids such as hydrochloric acid, sulfuric acid, ammonium chloride, and the like; saturated fatty acids such as acetic acid, formic acid, propionic acid, butyric acid, valeric acid, caproic acid, and the like; unsaturated fatty acids such as acrylic acid, crotonic acid, oleic acid, and the like; aromatic carboxylic acids such as benzoic acid, phthalic acid, salicylic acid, and the like; dicarboxylic acids such as oxalic acid, maleic acid, fumaric acid, and the like; methanesulfonic acid, paratoluenesulfonic acid, and the like, among which hydrochloric acid, acetic acid, and ammonium chloride are preferred. In addition, before and after washing with the acidic aqueous solution, washing with water or an organic solvent such as acetone may be performed as necessary. For example, when the cooling crystallization temperature (Tc) is low, the cooling crystallization temperature (Tc) of the (A) polyarylene sulfide resin can be increased to 215° C. or more by washing the (A) polyarylene sulfide resin with the above-mentioned compounds (e.g., acetic acid, ammonium chloride, and the like).

The method for producing the (A) polyarylene sulfide resin is not particularly limited, and it can be produced by a conventionally known production method. For example, it can be produced by synthesizing a low molecular weight polyarylene sulfide resin, and then polymerizing it at a high temperature in the presence of a known polymerization aid to increase the molecular weight. It may also be produced by blending multiple types of polyarylene sulfide resins. In this case, it can also be produced by combining polyarylene sulfide resins having different melt viscosities. When combining polyarylene sulfide resins having different melt viscosities, it is preferable that the melt viscosity of the obtained resin is within the above ranges. In addition, two or more polyarylene sulfide resins having different cooling crystallization temperatures (Tc) can also be used in combination within a range in which the cooling crystallization temperature (Tc) of the obtained resin is 215° C. or more.

Polyarylene sulfide resins produced by general polymerization methods are usually washed several times with water or an organic solvent such as acetone to remove by-product impurities, and the like. As described above, in one embodiment, the (A) polyarylene sulfide resin may then be further washed with acetic acid, ammonium chloride, and the like.

In one embodiment, the content of the (A) polyarylene sulfide resin in the resin composition is preferably 30% by mass or more, and more preferably 35% by mass or more. In one embodiment, the content of the (A) polyarylene sulfide resin in the resin composition may be 30 to 70% by mass, 30 to 65% by mass, or 35 to 60% by mass.

In one embodiment, preferably 80% by mass or more, and more preferably 90% by mass or more of the thermoplastic resin contained in the resin composition may be the (A) polyarylene sulfide resin. In one embodiment, the thermoplastic resin contained in the resin composition may be composed of only the (A) polyarylene sulfide resin.

### < (B) Fibrous Inorganic Filler>

The resin composition contains a fibrous inorganic filler (hereinafter, also referred to simply as “(B) fibrous inorganic filler”) having a different diameter ratio, which is the ratio (long diameter of the cross section/short diameter of the cross section) of the long diameter and short diameter of a cross section perpendicular to the longitudinal direction, of 3.0 or more (hereinafter referred to simply as “different diameter ratio”).

The “long diameter of the cross section perpendicular to the longitudinal direction” is the longest linear distance in the cross section perpendicular to the longitudinal direction of the fibers, and the “short diameter of the cross section perpendicular to the longitudinal direction” is the longest linear distance in the perpendicular direction to the long diameter in the cross section. The different diameter ratio refers to the different diameter ratio of the initial shape (shape before melt kneading). The different diameter ratio can be calculated using a scanning electron microscope and image processing software, and is the arithmetic average value measured for 10 (B) fibrous inorganic fillers. The different diameter ratio can also employ the manufacturer's values (values published by the manufacturer in a catalog and the like).

In general, the mechanical strength of a resin molded article can be measured by the following indicators: tensile strength, which indicates the strength when a tensile force is applied to the molded article; flexural strength, which indicates the strength when a flexural load is applied to the molded article; and impact strength, which indicates the strength when an impact is applied to the molded article. Since these indicators are different in the direction in which force is applied and the method in which the force is applied, it is not the case that if one indicator is excellent, the other indicators are also excellent. For example, even if the tensile strength is excellent, the flexural strength is not necessarily excellent. The resin composition according to the present embodiment can provide a molded article having, of mechanical strength, particularly excellent flexural strength and impact strength, by using a (A) polyarylene sulfide resin in combination with a (B) fibrous inorganic filler having a prescribed different diameter ratio and an (C) alkoxysilane compound described below in a prescribed amount.

The different diameter ratio of the (B) fibrous inorganic filler is 3.0 or more, preferably 3.5 or more, and more preferably 3.8 or more. The upper limit value of the different diameter ratio is 10.0 or less, preferably 8.0 or less, and more preferably 6.0 or less. In one embodiment, the different diameter ratio of the (B) fibrous inorganic filler may be 3.0 to 10.0, may be 3.5 to 8.0, and may be 3.8 to 6.0. In one embodiment, the different diameter ratio of the (B) fibrous inorganic filler may be 4.0 or may be within the range in which this is the upper limit value or lower limit value of the above-mentioned numerical range.

Examples of the (B) fibrous inorganic filler include, for example, fibrous inorganic fillers whose cross-sectional shape perpendicular to the longitudinal direction of the fibers is oval, semicircular, cocoon-shaped (an oval shape with a portion of the longitudinal direction recessed inward), rectangular, or similar shapes.

The long diameter of the cross section perpendicular to the longitudinal direction of the (B) fibrous inorganic filler is preferably 10 to 40 μm, and more preferably 20 to 30 μm.

The short diameter of the cross section perpendicular to the longitudinal direction of the (B) fibrous inorganic filler is preferably 1 to 20 μm, and more preferably 3 to 10 μm.

The long diameter and short diameter of the cross section perpendicular to the longitudinal direction can both be calculated using a scanning electron microscope and image processing software, and are the arithmetic average values measured for 10 (B) fibrous inorganic fillers. Furthermore, the long diameter and short diameter of the cross section perpendicular to the longitudinal direction can also employ the manufacturer's values (values published by the manufacturer in a catalog, and the like).

From the viewpoint of further increasing the flexural strength and impact strength of the molded article, the average fiber length of the (B) fibrous inorganic filler is preferably 0.01 to 3.5 mm, more preferably 0.05 to 3.5 mm, even more preferably 0.1 to 3.5 mm, and particularly preferably 0.5 to 3 mm as the average fiber length (cut length) before melt-kneading in the resin composition. The average fiber length can be calculated using a scanning electron microscope and image processing software, and is the arithmetic average value measured for 1,000 (B) fibrous inorganic fillers. The average fiber length can also employ the manufacturer's values (values published by the manufacturer in a catalog, and the like).

The average fiber length of the (B) fibrous inorganic filler in the molded article is preferably 50 to 1000 μm, and more preferably 100 to 900 μm, from the viewpoint of further increasing the flexural strength and impact strength of the molded article. The average fiber length of the (B) fibrous inorganic filler in the molded article can be calculated by heating the molded article at 600° C. for three to five hours, dispersing 3 mg of the residue obtained by incineration in a 5% aqueous polyethylene glycol solution, stirring thoroughly, then transferring 10 mL of the solution to a petri dish, and using an image measuring device. The arithmetic average value measured for 1,000 (B) fibrous inorganic fillers is used.

From the viewpoint of ease of production, the cross-sectional area of the (B) fibrous inorganic filler is preferably 1×10⁵ to 1×10⁻³ mm², and more preferably 1×10⁻⁴ to 5×10⁻⁴ mm². The “cross-sectional area” can be calculated, when the longest linear distance of the cross section of (B) fibrous inorganic filler is the long diameter and when shortest linear distance of the cross section of (B) fibrous inorganic filler is the short diameter measured using a scanning electron microscope and image processing software, by dividing the long diameter by two, by dividing the short diameter by two, by multiplying the values of said division, and then by multiplying by pi π. The cross-sectional area is the arithmetic average value measured for 10 (B) fibrous inorganic fillers.

Examples of the material for the (B) fibrous inorganic filler include mineral fibers such as glass fibers, carbon fibers, zinc oxide fibers, titanium oxide fibers, wollastonite, silica fibers, silica-alumina fibers, zirconia fibers, boron nitride fibers, silicon nitride fibers, boron fibers, and potassium titanate fibers, and metal fibrous substances such as stainless steel fibers, aluminum fibers, titanium fibers, copper fibers, brass fibers, and the like, and it is preferable to use one or two or more selected from these. Among these, it is more preferable to include glass fibers. In addition, hollow fibers can also be used as the (B) fibrous inorganic filler for the purpose of reducing the specific gravity of the resin composition.

The (B) fibrous inorganic filler may be surface-treated with various surface treatment agents such as commonly known epoxy-based compounds, isocyanate-based compounds, silane-based compounds, titanate-based compounds, fatty acids, and the like. The surface treatment can improve adhesion to the (A) polyarylene sulfide-based resin. The surface treatment agent may be applied to the (B) fibrous inorganic filler in advance before the material preparation to perform surface treatment or convergence treatment, or may be added simultaneously during the material preparation.

The content of the (B) fibrous inorganic filler is 55 to 180 parts by mass, preferably 58 to 170 parts by mass, more preferably 60 to 160 parts by mass, and even more preferably 65 to 155 parts by mass per 100 parts by mass of the (A) polyarylene sulfide-based resin. By having the content of the (B) fibrous inorganic filler be 55 to 180 parts by mass per 100 parts by mass of the (A) polyarylene sulfide-based resin, a synergistic effect can be sufficiently obtained by using in combination with the (C) alkoxysilane compound described below, and the flexural strength and impact strength of the molded article can be increased.

In one embodiment, the content of the (B) fibrous inorganic filler can be 68 to 153 parts by mass per 100 parts by mass of the (A) polyarylene sulfide-based resin. In one embodiment, the content of the (B) fibrous inorganic filler may be 68 parts by mass, 101 parts by mass, 102 parts by mass, or 153 parts by mass per 100 parts by mass of the (A) polyarylene sulfide-based resin, or may be a range with these as upper or lower limit values.

The content of the (B) fibrous inorganic filler in the resin composition is preferably 35 to 65% by mass, and more preferably 36 to 64% by mass. In one embodiment, the content of the (B) fibrous inorganic filler in the resin composition may be 40 to 61% by mass.

As described below, the resin composition may contain other inorganic fillers other than the (B) fibrous inorganic filler, as necessary, but the content of the (B) fibrous inorganic filler in the total inorganic fillers is preferably 50% by mass or more, more preferably 80% by mass by or more, and even more preferably 90% by mass or more. In one embodiment, the inorganic filler may be composed of the (B) fibrous inorganic filler.

### <Other Inorganic Fillers>

The resin composition may contain, as necessary, other inorganic fillers in addition to the (B) fibrous inorganic filler. Examples of the other inorganic fillers include a fibrous inorganic filler other than the (B) fibrous inorganic filler and a non-fibrous inorganic filler.

Examples of the fibrous inorganic filler other than the (B) fibrous inorganic filler include a fibrous filler whose different diameter ratio, which is the ratio of the long diameter and the short diameter of the cross section perpendicular to the longitudinal direction, is less than 3.0, less than 2.0, or 1.5 or less. Examples of the fibrous inorganic filler other than the (B) fibrous inorganic filler include, for example, a fibrous inorganic filler whose cross-sectional shape perpendicular to the longitudinal direction of the fibers is round or square. The material of the fibrous inorganic filler other than the (B) fibrous inorganic filler is not limited, and can include the fibrous fillers exemplified in the above-mentioned (B) fibrous inorganic filler, and can include one or more selected therefrom. The materials of the (B) fibrous inorganic filler and the fibrous inorganic filler other than the (B) fibrous inorganic filler may be the same or different. The average fiber length and average fiber diameter of the other fibrous inorganic filler are not limited.

Examples of the non-fibrous inorganic filler include a powdered granular inorganic filler and a plate-like inorganic filler.

Examples of the powdered granular inorganic filler include carbon black, silicates such as silica, quartz powder, glass beads, glass powder, talc (granular), calcium silicate, aluminum silicate, and diatomaceous earth, metal oxides such as iron oxide, titanium oxide, zinc oxide, and alumina, metal carbonates such as calcium carbonate and magnesium carbonate, metal sulfates such as calcium sulfate and barium sulfate, as well as silicon carbide, silicon nitride, boron nitride, and various metal powders, and may contain one or more selected from these. Examples of the plate-like inorganic filler include, for example, glass flakes, talc (plate-like), mica, kaolin, clay, alumina, and various metal foils, and may contain one or more selected from these. The average particle diameter (D50) of the non-fibrous inorganic filler is not limited and may be, for example, 0.1 to 100 μm.

The content of the other inorganic filler is not limited, and may be, for example, 0 to 50 parts by mass, or less than 40 parts by mass per 100 parts by mass of the (A) polyarylene sulfide resin. In one embodiment, it is preferable that the amount of the other inorganic filler is small.

In one embodiment, the content of the inorganic fibrous filler having a different diameter ratio, which is the ratio of the long diameter and the short diameter of a cross section perpendicular to the longitudinal direction, of less than 3.0 is preferably less than 1 part by mass, more preferably less than 0.5 parts by mass, and even more preferably less than 0.1 parts by mass per 100 parts by mass of the (A) polyarylene sulfide resin. In one embodiment, it is also possible to configure so as not to include a fibrous filler having a different diameter ratio, which is the ratio of the long diameter and the short diameter of a cross section perpendicular to the longitudinal direction, of less than 3.0.

### <(C) Alkoxysilane Compound>

The resin composition contains an (C) alkoxysilane compound. The (C) alkoxysilane compound preferably contains one or two or more alkoxysilane compounds having one or more groups selected from an epoxy group, an amino group, a vinyl group, a (meth)acrylic group, an isocyanate group, and a mercapto group.

In one embodiment, the (C) alkoxysilane compound is preferably represented by the following formula (II):

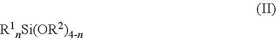

In formula (II), R¹ is an alkyl group having 1 to 18 carbon atoms (preferably 1 to 10) and having an epoxy group, an amino group, a vinyl group, a (meth)acrylic group, an isocyanate group, or a mercapto group, R² is an alkyl group having 1 to 4 carbon atoms, and n is an integer from 1 to 3.

Examples of the (C) alkoxysilane compound include alkoxysilanes such as, for example, epoxy alkoxysilanes, amino alkoxysilanes, vinyl alkoxysilanes, (meth)acryl alkoxysilanes, isocyanate alkoxysilanes, and mercapto alkoxysilanes, and it is preferable to contain one or two or more of these. The number of carbon atoms in the alkoxy group is preferably 1 to 10, and particularly preferably 1 to 4. The (C) alkoxysilane compound may contain one or two or more of these.

Examples of epoxy alkoxysilanes include, for example, γ-glycidoxy propyltrimethoxysilane, β-(3,4-epoxy cyclohexyl) ethyl trimethoxysilane, and γ-glycidoxy propyltriethoxysilane.

Examples of amino alkoxysilanes include, for example, γ-amino propyltrimethoxysilane, γ-amino propyltriethoxysilane, γ-amino propylmethyl dimethoxysilane, γ-amino propylmethyl diethoxysilane, N-(β-aminoethyl)-γ-amino propyltrimethoxysilane, N-phenyl-γ-amino propyltrimethoxysilane, γ-diallylamino propyltrimethoxysilane, and γ-diallylamino propyltriethoxysilane.

Examples of vinyl alkoxysilanes include, for example, vinyl trimethoxysilane, vinyl triethoxysilane, and vinyl tris(β-methoxyethoxy) silane.

Examples of the (meth)acryl alkoxysilanes include, for example, γ-acryl oxypropyltriethoxysilane, γ-acryl oxypropyltrimethoxysilane, γ-methacryl oxypropyltriethoxysilane, γ-methacryl oxypropyltrimethoxysilane, γ-methacryl oxypropylmethyldimethoxysilane, and γ-methacryl oxypropylmethyldiethoxysilane.

Examples of the isocyanate alkoxysilanes include, for example, γ-isocyanate propyltriethoxysilane and γ-isocyanate propyltrimethoxysilane.

Examples of mercapto alkoxysilanes include, for example, γ-mercapto propyltrimethoxysilane and γ-mercapto propyltriethoxysilane.

Among these, it is more preferable that the compound contains one or more selected from epoxy alkoxysilanes and amino alkoxysilanes, and it is particularly preferable that the compound contains γ-amino propyltriethoxysilane.

The content of the (C) alkoxysilane compound is 0.5 to 10 parts by mass, preferably 0.6 to 8 parts by mass, and more preferably 0.7 to 4.5 parts by mass per 100 parts by mass of the (A) polyarylene sulfide resin. By having the content of the (C) alkoxysilane compound be 0.5 to 10 parts by mass per 100 parts by mass of the (A) polyarylene sulfide resin, a synergistic effect by using the (B) fibrous inorganic filler in combination can be sufficiently obtained, and the flexural strength and impact strength of the molded article can be increased.

In one embodiment, the content of the (C) alkoxysilane compound may be 0.5 parts by mass, 1.0 parts by mass, 1.2 parts by mass, or 1.5 parts by mass per 100 parts by mass of the (A) polyarylene sulfide resin, or may be a range with these as upper or lower limit values.

As described above, the (B) fibrous inorganic filler can be surface-treated with a silane-based compound or the like. In one embodiment, when the (B) fibrous inorganic filler is surface-treated with an alkoxysilane compound, the (C) alkoxysilane compound content can include the content of alkoxysilane compound derived from a surface treatment agent. Even in this case, the (C) alkoxysilane compound content is preferably within the above ranges.

### <Other Additives>

The resin composition may contain known additives generally added to thermoplastic resins and thermosetting resins according to the required performance in order to impart desired properties according to the purpose, so long that the effects of the present invention are not impaired. Examples of additives include burr inhibitors, mold release agents, lubricants, plasticizers, flame retardants, colorants such as dyes and pigments, crystallization accelerators, crystal nucleating agents, various antioxidants, thermal stabilizers, weather resistance stabilizers, corrosion inhibitors, and the like. Examples of mold release agents include polyethylene wax, fatty acid esters, fatty acid amides, and the like. Examples of crystal nucleating agents include boron nitride, talc, kaolin, carbon black, carbon nanotubes, and the like. Examples of corrosion inhibitors include zinc oxide, zinc carbonate, and the like. The content of the above additives can be 5% by mass or less in the total resin composition.

Further, in addition to the above components, the resin composition may also supplementarily contain small amounts of other thermoplastic resin components to be used in combination according to the purpose. The other thermoplastic resins used here may be any resin that is stable at high temperatures. Examples include, for example, aromatic polyesters containing aromatic dicarboxylic acids and diols, or oxycarboxylic acids, such as polyethylene terephthalate and polybutylene terephthalate, polyamides, polycarbonates, ABS, polyphenylene oxides, polyalkyl acrylates, polysulfones, polyethersulfones, polyetherimides, polyether ketones, fluororesins, liquid crystal polymers, cyclic olefin copolymers, and the like. In addition, two or more of these thermoplastic resins can be mixed and used. The content of the other thermoplastic resin components can be, for example, 20% by mass or less in the total resin composition.

### (Production Method of Polyarylene Sulfide Resin Composition)

The production method of the resin composition is not particularly limited, and the above-mentioned components can be melt-kneaded and produced by a known method. For example, any of the following methods can be used: a method in which the components are mixed, then kneaded and extruded in an extruder to prepare pellets; a method in which pellets with different compositions are first prepared, prescribed amounts of the pellets are mixed and molded to obtain a molded article with the target composition after molding; and a method in which one or two or more of the components are directly charged in a molding machine.

The resin composition leads to a molded article having a tensile strength (TS) of preferably 195 MPa or more. If the TS is 195 MPa or more, it can be said that the molded article has a tensile strength equal to or greater than that of a conventional one. According to the resin composition of the present embodiment, a molded article having a tensile strength equal to or greater than that of a conventional one can be obtained. The tensile strength (TS) is a value obtained by drying pellets of the resin composition at 140° C. for three hours and then injection molding at a cylinder temperature of 320° C. and a mold temperature of 150° C. to prepare an A-type test piece (width 10 mm, thickness 4 mmt) in compliance with ISO 3167:93, using this test piece, and measuring in compliance with ISO 527-1,2.

The resin composition leads to a molded article having a flexural strength (FS) of preferably 290 MPa or more, and more preferably 300 MPa or more. According to the resin composition of the present embodiment, a molded article having improved flexural strength compared with a conventional one can be obtained. The flexural strength (FS) is a value obtained by drying pellets of the resin composition at 140° C. for three hours and then injection molding at a cylinder temperature of 320° C. and a mold temperature of 150° C. to prepare a test piece (width 10 mm, thickness 4 mmt) in compliance with ISO 316, using this test piece, and measuring in compliance with ISO178.

The resin composition has a Charpy impact strength (notched) of a molded article of preferably 11.0 KJ/m² or more, more preferably 11.5 KJ/m² or more, and even more preferably 15.0 KJ/m² or more. According to the resin composition of the present embodiment, a molded article having improved Charpy impact strength compared with a conventional one can be obtained. The Charpy impact strength is a value obtained by drying pellets of the resin composition at 140° C. for three hours, and then preparing a test piece (width 10 mm, thickness 4 mmt, notched) in compliance with ISO 316 at a cylinder temperature of 320° C. and a mold temperature of 150° C. by injection molding, using this test piece, and measuring in compliance with ISO 179-1.

### (Applications)

The resin composition of the present embodiment can provide molded articles having excellent flexural strength and impact strength, and can be used for various applications such as electrical and electronic device part materials, automobile part materials, chemical device part materials, and the like.

### EXAMPLES

The present invention will be described in more detail below with reference to examples, but the interpretation of the present invention is not limited to these examples.

### Examples 1-7 and Comparative Examples 1-11

Using the materials shown below, a polyarylene sulfide resin, a fibrous inorganic filler, and an alkoxysilane compound were dry-blended in the composition and content ratio shown in Table 1. This was fed into a twin-screw extruder with a cylinder temperature of 320° C. (glass fibers were added separately from the side feed part of the extruder) and melt-kneaded to obtain resin composition pellets of the examples and comparative examples.

### (Polyarylene Sulfide Resin)

PPS-1: Polyphenylene sulfide resin, “Fortron KPS” manufactured by Kureha Corporation (melt viscosity: 30 Pa·s (shear rate: 1200 sec⁻¹, 310° C.), Tc: 219° C.)
PPS-2: Polyphenylene sulfide resin synthesized using the following method (Tc: 183° C.)

### (Synthesis Method of PPS-2)

5700 g of NMP was charged into a 20 L autoclave, and after replacing with nitrogen gas, the temperature was raised to 100° C. over approximately one hour while stirring at a stirrer speed of 250 rpm. After reaching 100° C., 1170 g of an aqueous NaOH solution with a concentration of 74.7% by weight, 1990 g of an aqueous sulfur source solution (containing 21.8 mol of NaSH and 0.50 mol of Na₂S), and 1000 g of NMP were added, and the temperature was gradually raised to 200° C. over approximately two hours, and 945 g of water, 1590 g of NMP, and 0.31 mol of hydrogen sulfide were discharged to the outside of the system.

After the above dehydration process, the content was cooled to 170° C., and 3459 g of p-DCB, 2800 g of NMP, 133 g of water, and 23 g of NaOH with a concentration of 97% by weight were added, and the temperature inside the autoclave reached 130° C. Then, while stirring at a stirrer speed of 250 rpm, the mixture was heated to 180° C. over 30 minutes, and then heated from 180° C. to 220° C. over 60 minutes. After 60 minutes of reaction at that temperature, the mixture was heated to 230° C. over 30 minutes, and reacted at 230° C. for 90 minutes to carry out a prior stage polymerization.

After the prior stage polymerization was completed, the stirrer speed was immediately increased to 400 rpm, and 340 g of water was pressure-injected. After the water pressure-injecting, the mixture was heated to 260° C. over one hour, and reacted at that temperature for five hours to carry out a latter stage polymerization. After the latter stage polymerization was completed, the reaction mixture was cooled to near room temperature, and the content was sieved through a 100 mesh screen to obtain a granular polymer, which was then washed with acetone three times and water five times to obtain a washed granular polymer. The granular polymer was dried at 105° C. for 13 hours. The granular polymer thus obtained had a melt viscosity (shear rate: 1200 sec⁻¹, 310° C.) of 30 Pa·s. This operation was repeated five times and the required amount of polymer (PPS-2) was obtained.

### (Melt Viscosity Measurement of PPS Resin)

The melt viscosity of the above PPS resin was measured as follows. Using a capillograph manufactured by Toyo Seiki Seisaku-sho, Ltd. and using a flat die of 1 mm ø×20 mm length as a capillary, the melt viscosity was measured at a barrel temperature of 310° C. and a shear rate of 1200 sec⁻¹.

### (Measurement Method of Tc)

The Tc of the above PPS resin was measured as follows.

Approximately 5 mg of PPS resin was weighed out and, using a DSC-8500 differential scanning calorimeter manufactured by PerkinElmer, the temperature was increased at a rate of 10° C./min, held at 340° C. for five minutes, and then decreased at a rate of 10° C./min. The crystallization peak (exothermic peak) temperature was read from the resulting DSC chart to determine Tc.

### (Fibrous Inorganic Filler)

GF1: Glass fiber, Nippon Electric Glass Co., Ltd., Flat glass fiber ESC03T-760-FGF, cross section oval, long diameter 28 μm, short diameter 7 μm, long diameter/short diameter ratio 4.0, average fiber length 3 mm
GF2: Glass fiber, Nitto Boseki Co., Ltd., irregular cross section chopped strand CSG 3PA-830, cross section oval, long diameter 28 μm, short diameter 7 μm, long diameter/short diameter ratio 4.0, average fiber length 3 mm
Comparative GF: Glass fiber, Nippon Electric Glass Co., Ltd., chopped strand ECS 03T-717, cross section almost circular, long diameter 13 μm, short diameter 13 μm, long diameter/short diameter ratio 1.0, average fiber length 3 mm

### (Alkoxysilane Compound)

Alkoxysilane compound: γ-amino propyltriethoxysilane, Shin-Etsu Chemical Co., Ltd. “KBE-903P”

[Measurement]

### (Tensile Strength: TS)

The resin composition pellets obtained in the examples and comparative examples were dried at 140° C. for three hours, and then injection molded to produce A-type test pieces (width 10 mm, thickness 4 mmt) in compliance with ISO 3167:93 at a molding cylinder temperature of 320° C. and a mold temperature of 150° C. Using these test pieces, the tensile strength (MPa) was measured in compliance with ISO 527-1, 2. The results are shown in Table 1. A tensile strength of 195 MPa or more is evaluated as having a tensile strength equal to or greater than that of a conventional one.

### (Flexural Strength: FS)

The resin composition pellets obtained in the examples and comparative examples were dried at 140° C. for three hours, and then injection molded to prepare test pieces (width 10 mm, thickness 4 mmt) in compliance with ISO 316 at a molding cylinder temperature of 320° C. and a mold temperature of 150° C. Using these test pieces, the flexural strength (MPa) was measured in compliance with ISO 178. The results are shown in Table 1. A flexural strength of 290 MPa or more is evaluated as excellent.

### (Charpy Impact Strength (Notched))

The resin composition pellets obtained in the examples and comparative examples were dried at 140° C. for three hours, and then injection molded to prepare test pieces (width 10 mm, thickness 4 mmt) in compliance with ISO316 at a molding cylinder temperature of 320° C. and a mold temperature of 150° C. Using these test pieces, the Charpy impact strength (notched) (KJ/m²) was measured in compliance with ISO179-1. The results are shown in Table 1. If the Charpy impact strength is 11.0 KJ/m² or more, the impact strength is evaluated as excellent.

TABLE 1

| | | | | | | | | COMP | COMP | COMP |
|---|---|---|---|---|---|---|---|---|---|---|
| | EX 1 | EX 2 | EX 3 | EX 4 | EX 5 | EX 6 | EX 7 | EX 1 | EX 2 | EX 3 |
| PPS-1 | 100 | 100 | 100 | 100 | 100 | 100 | 100 | 100 | 100 | 100 |
| PPS-2 | — | — | — | — | — | — | — | — | — | — |
| ALKOXYSILANE COMPOUND | 1.0 | 0. [symbol] | 1.2 | 1. [symbol] | 1.0 | 1.2 | 1. [symbol] | 1.0 | 1.2 | 1. [symbol] |
| GF1 | 68 | 101 | 102 | [symbol] | — | — | — | — | — | — |
| GF2 | — | — | — | — | [symbol] | 10 [symbol] | 15 [symbol] | — | — | — |
| COMPARATIVE GF | — | — | — | — | — | — | — | [symbol] | [symbol] | 1 [symbol] |
| TENSILE STRENGTH [symbol] TS (MPa) | [symbol] 00 | [symbol] | 20 [symbol] | 1 [symbol] | [symbol] 10 | [symbol] 00 | [symbol] | [symbol] | [symbol] | [symbol] |
| FLEXURAL STRENGTH FS (MPa) | [symbol] | [symbol] 01 | [symbol] 0 | [symbol] | [symbol] | [symbol] | [symbol] | [symbol] | [symbol] | [symbol] |
| CHARPY IMPACT STRENGTH | 11.7 | 1 [symbol] | 15.4 | 1 [symbol] .0 | 1 [symbol] | 1 [symbol] | 1 [symbol] | 1 [symbol] | [symbol] | [symbol] |
| (NOTCHED) ( [symbol] ) | | | | | | | | | | |

| | COMP | COMP | COMP | COMP | COMP | COMP | COMP | COMP |
|---|---|---|---|---|---|---|---|---|
| | EX 4 | EX 5 | EX 6 | EX 7 | EX 8 | EX 9 | EX 10 | EX 11 |
| PPS-1 | 100 | 100 | 100 | 100 | — | 100 | 100 | 100 |
| PPS-2 | — | — | — | — | 100 | — | — | — |
| ALKOXYSILANE COMPOUND | — | — | — | 0.1 | 1.2 | — | — | — |
| GF1 | — | — | — | 101 | — | — | — | — |
| GF2 | — | — | — | — | 10 [symbol] | [symbol] | 10 [symbol] | 1 [symbol] |
| COMPARATIVE GF | [symbol] | 100 | 1 [symbol] | — | — | — | — | — |
| TENSILE STRENGTH TS (MPa) | 1 [symbol] | 1 [symbol] | 1 [symbol] | [symbol] | 1 [symbol] | 1 [symbol] | [symbol] 00 | 1 [symbol] |
| FLEXURAL STRENGTH FS (MPa) | [symbol] | [symbol] | [symbol] | [symbol] | [symbol] | [symbol] | [symbol] | [symbol] |
| CHARPY IMPACT STRENGTH | [symbol] | [symbol] | [symbol] | [symbol] | 1 [symbol] | 11 [symbol] | 1 [symbol] | 17.9 |
| (NOTCHED) ( [symbol] ) | | | | | | | | |

[symbol]

indicates data missing or illegible when filed

As shown in Table 1, the resin compositions of examples 1 to 7 all have a flexural strength of 290 MPa or more and a Charpy impact strength of 11.0 KJ/m² or more, and can provide molded articles with excellent flexural strength and impact strength. In addition, all have a tensile strength of 195 MPa or more, and can achieve a tensile strength equal to or greater than that of conventional ones.

In contrast, the resin compositions of comparative examples 1 to 6 use a fibrous inorganic filler with a different diameter ratio of less than 3.0, and even if they contain an alkoxysilane compound as in comparative examples 1 to 3, they are unable to achieve both excellent flexural strength and impact strength.

The resin composition of comparative example 7 contains an alkoxysilane compound less than 0.5 parts by mass per 100 parts by mass of polyarylene sulfide resin, resulting in poor flexural strength.

The resin composition of comparative example 8 has a polyarylene sulfide resin with a cooling crystallization temperature (Tc) of less than 215° C., resulting in poor flexural strength.

The resin compositions of comparative examples 9 to 11 did not contain an alkoxysilane compound, and even when a fibrous inorganic filler with a different diameter ratio of 3.0 or more was used, the flexural strength was poor.

Furthermore, as shown in comparative examples 1, 7, 8, 10, and 11, even when the tensile strength was high, exceeding 195 MPa, the effect of improving flexural strength was not obtained.

### INDUSTRIAL APPLICABILITY

Since the resin composition of the present embodiment can provide molded articles having excellent flexural strength and impact strength, it can be suitably used for electrical and electronic device part materials, automobile part materials, chemical device part materials, and the like, and has industrial applicability.

1. A polyarylene sulfide resin composition comprising:
a (A) polyarylene sulfide resin;
a (B) fibrous inorganic filler having a different diameter ratio, which is a ratio of the long diameter and short diameter of a cross section perpendicular to the longitudinal direction, of 3.0 or more; and
an (C) alkoxysilane compound,
wherein a cooling crystallization temperature (Tc) of the (A) polyarylene sulfide resin is 215° C. or more, and the cooling crystallization temperature (Tc) is an exothermic peak temperature associated with crystallization observed when the (A) polyarylene sulfide resin is heated to 340° C., melted, and then cooled at a rate of 10° C./min with a differential scanning calorimeter;
the content of the (B) fibrous inorganic filler having a different diameter ratio, which is the ratio of the long diameter and short diameter of a cross section perpendicular to the longitudinal direction, of 3.0 or more is 55 to 180 parts by mass per 100 parts by mass of the (A) polyarylene sulfide resin; and
the content of the (C) alkoxysilane compound is 0.5 to 10 parts by mass per 100 parts by mass of the (A) polyarylene sulfide resin.

2. The polyarylene sulfide resin composition according to claim 1, wherein the (C) alkoxysilane compound comprises one or more alkoxysilane compounds comprising one or more selected from an epoxy group, an amino group, a vinyl group, a (meth)acrylic group, an isocyanate group, and a mercapto group.

3. The polyarylene sulfide resin composition according to claim 1, wherein the (B) fibrous inorganic filler having a different diameter ratio, which is the ratio of the long diameter and short diameter of a cross section perpendicular to the longitudinal direction, of 3.0 or more comprises glass fibers.
